(19) United States
(12) Patent Application Publication
(10) Pub. No.: US 2012/0262388 A1
(43) Pub. Date: Oct. 18, 2012

(54) MOBILE DEVICE AND METHOD FOR CONTROLLING MOBILE DEVICE

(75) Inventors: Kai-Yu HUANG, Taipei Hsien (TW); Chao-Kuang Yang, Taipei Hsien (TW)

(73) Assignee: ACER INCORPORATED, Taipei Hsien (TW)

(21) Appl. No.: 13/415,515

(22) Filed: Mar. 8, 2012

(30) Foreign Application Priority Data
Mar. 9, 2011 (TW) 100107857

(51) Int. Cl. G06F 3/041

(52) U.S. Cl. 345/173

(57) ABSTRACT

A mobile device includes a touch screen, an unlocking key, a function key and a processor. The unlocking key transmits a first command to the processor when pressed. The function key transmits a second command to the processor when pressed.

The processor is coupled to the touch screen, the unlocking key and the function key. The processor operates in a standby mode and is configured to: display a first user interface on the touch screen when the processor receives the first command; display a second user interface on the touch screen when the processor receives the second command; switch to a normal work mode when the first user interface of the touch screen detects that the touch gesture is an unlocking touch gesture; and switch to a special work mode and enable a first function when the second user interface of the touch screen detects a first touch gesture.

### CROSS REFERENCE TO RELATED APPLICATIONS

This Application claims priority of Taiwan Patent Application No. 100107857 filed on Mar. 9, 2011, the entirety of which is incorporated by reference herein.

### BACKGROUND OF THE INVENTION

1. Field of the Invention

The disclosure generally relates to a mobile device, and more particularly, relates to a mobile device for enabling multiple functions according to different unlocking keys.

2. Description of the Related Art

With the progress of mobile communication technology, portable electronic devices, for example, portable computers, mobile phones, multimedia players, and other hybrid functional portable electronic devices, have become more common.

A smart phone provides a user with variable and unique functions. For example, a smart phone using Android system generally includes many functions and application programs. If a user wants to run an application program in the smart phone, he should (1) turn on power of the smart phone, (2) unlock the smart phone, and (3) select the application program after entering a menu of application programs. The complicated steps cause inconvenience for the user.

### BRIEF SUMMARY OF THE INVENTION

In one exemplary embodiment, the disclosure is directed to a mobile device, comprising: a touch screen, detecting a touch gesture; an unlocking key, transmitting a first command when the unlocking key is pressed; a function key, transmitting a second command when the function key is pressed; and a processor, coupled to the touch screen, the unlocking key, and the function key, wherein the processor operates in a standby mode and is configured to: display a first user interface on the touch screen when the processor receives the first command; display a second user interface on the touch screen when the processor receives the second command; switch to a normal work mode when the first user interface of the touch screen detects that the touch gesture is an unlocking touch gesture; and switch to a special work mode and enable a first function when the second user interface of the touch screen detects a first touch gesture.

In another embodiment, the disclosure is directed to a method for controlling a mobile device, comprising the steps of: providing the mobile device, wherein the mobile device operates in a standby mode, and comprises an unlocking key and a function key; detecting input states of the unlocking key and the function key; when the unlocking key of the mobile device is pressed, displaying a first user interface by the mobile device; when the first user interface of the mobile device detects an unlocking touch gesture, switching the mobile device into a normal work mode; when the function key of the mobile device is pressed, displaying a second user interface by the mobile device; and when the second user interface of the mobile device detects a first touch gesture, switching the mobile device into a special work mode, and enabling a first function by the mobile device.

### BRIEF DESCRIPTION OF DRAWINGS

The invention can be more fully understood by reading the subsequent detailed description and examples with references made to the accompanying drawings, wherein:

FIG. 1 is a diagram for illustrating a mobile device according to an embodiment of the invention;

FIG. 2A is a diagram for illustrating a user interface of a touch screen according to an embodiment of the invention;

FIG. 2B is a diagram for illustrating another user interface of the touch screen according to an embodiment of the invention;

FIG. 3A is a diagram for illustrating an application program menu of the touch screen according to an embodiment of the invention;

FIG. 3B is a diagram for illustrating a camera interface of the touch screen according to an embodiment of the invention;

FIG. 3C is a diagram for illustrating a video recorder interface of the touch screen according to an embodiment of the invention;

FIG. 4A is a diagram for illustrating a music player menu of the touch screen according to another embodiment of the invention;

FIG. 4B is a diagram for illustrating a media player menu of the touch screen according to another embodiment of the invention; and

FIG. 5 is a flowchart for illustrating a method for controlling a mobile device according to another embodiment of the invention.

### DETAILED DESCRIPTION OF THE INVENTION

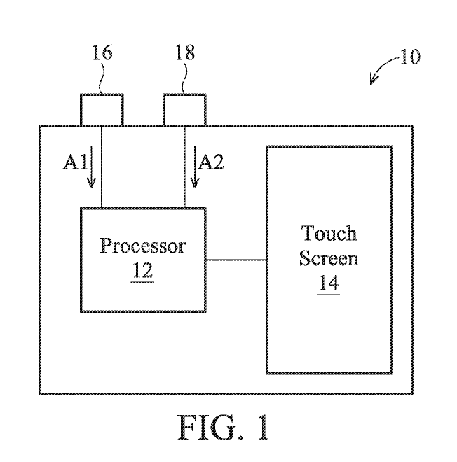

FIG. 1 is a diagram for illustrating a mobile device 10 according to an embodiment of the invention. The mobile phone 10 may be a smart phone, a tablet PC (Personal Computer), or a PDA (Personal Digital Assistant), etc. As shown in FIG. 1, the mobile device 10 comprises a processor 12, a touch screen 14, an unlocking key 16, and a function key 18. The processor 12 is electrically coupled to the touch screen 14, the unlocking key 16, and the function key 18, respectively. The touch screen 14 is configured to detect a touch gesture. The unlocking key 16 may be a power key (e.g., in a smart phone using Android or iOS) or a home key (e.g., in a smart phone using iOS) of the mobile device 10. The function key 18 is configured to enable multiple functions of the mobile device 10, such as a camera function, a video recorder function, a music player function, and/or a media player function. If the processor 12 of the mobile device 10 does not receive any command from a user during a time period, and/or if the processor 12 receives a standby command from the user during the time period, the processor 12 will operate in a standby mode, and the touch screen 14 will display a standby picture. When a user presses the unlocking key 16, the unlocking key 16 transmits a command A1 to the processor 12, and when the user presses the function key 18, the function key 18 transmits a command A2 to the processor 12.

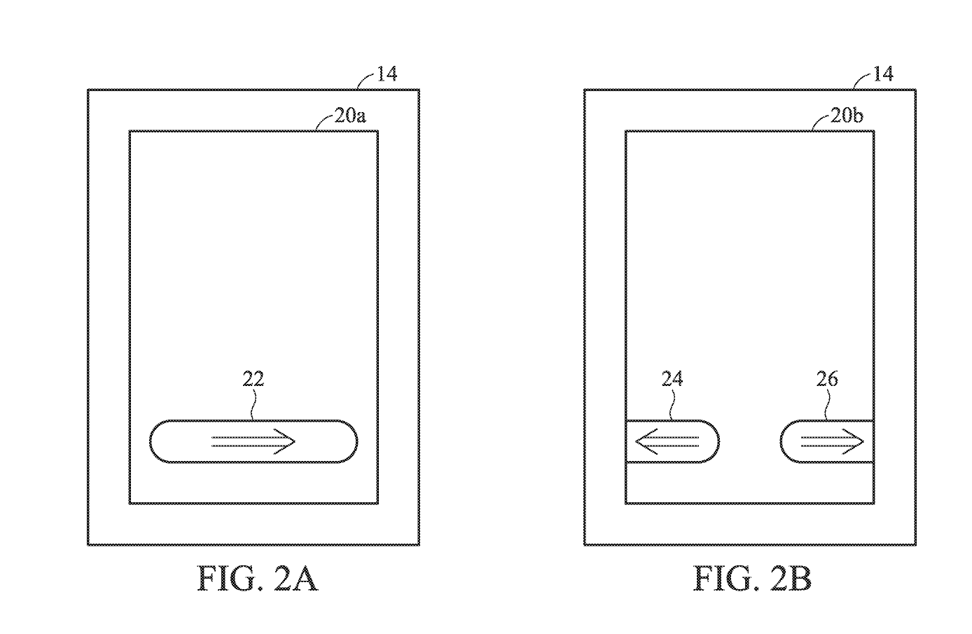

FIG. 2A is a diagram for illustrating a user interface 20a of the touch screen 14 according to an embodiment of the invention. FIG. 2B is a diagram for illustrating another user interface 20b of the touch screen 14 according to an embodiment of the invention. When receiving the command A1, the processor 12 displays the user interface 20a for unlocking normally on the touch screen 14, such as showing a touch sliding bar 22. When receiving the command A2, the processor 12 displays the user interface 20b for enabling one or more special functions, wherein the user interface 20b comprises two touch sliding bars 24 and 26 in different directions. Although the user interface 20b in FIG. 2B merely has two touch sliding bars, it can comprise more than 3 touch sliding bars, for example, four touch sliding bars in up, down, left and right directions, respectively. Also, the user interface 20b can include only one sliding bar for one special function.

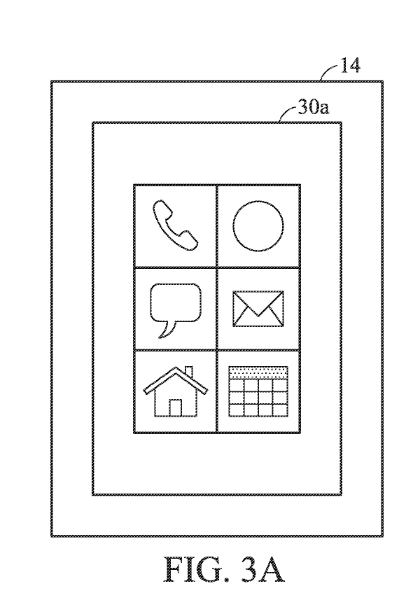

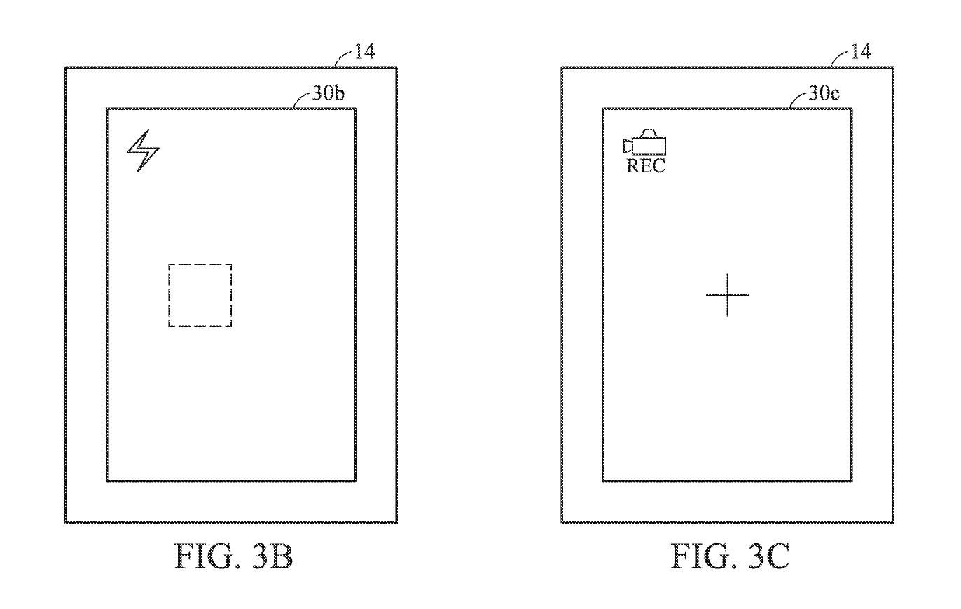

FIG. 3A is a diagram for illustrating an application program menu 30a of the touch screen 14 according to an embodiment of the invention. If a user wants to unlock and use the mobile device 10, he can press the unlocking key 16. Next, when the user interface 20a of the touch screen 14 detects that a touch gesture of the user is an unlocking touch gesture (e.g., a finger of the user slides on the touch sliding bar 22 in the right direction), the processor 12 of the mobile device 10 switches to a normal work mode and is able to receive operation commands from the user (e.g., the processor 12 displays the application program menu 30a on the touch screen 14). On the other hand, if the user wants to enable a special function of the mobile device 10 quickly, he can press the function key 18. When the user interface 20b of the touch screen 14 detects a first touch gesture of the user (e.g., a finger of the user slides on the touch sliding bar 24 in the left direction), the processor 12 of the mobile device 10 switches to a special work mode and enables a first function. In addition, when the user interface 20b of the touch screen 14 detects a second touch gesture of the user (e.g., a finger of the user slides on the touch sliding bar 26 in the right direction), the processor 12 of the mobile device 10 switches to the special work mode and enables a second function.

FIG. 3B is a diagram for illustrating a camera interface 30b of the touch screen 14 according to an embodiment of the invention. FIG. 3C is a diagram for illustrating a video recorder interface 30c of the touch screen 14 according to an embodiment of the invention. In the embodiment, the first function is a camera function, and the second function is a video recorder function. When enabling the first function, the processor 12 displays the camera interface 30b on the touch screen 14. When enabling the second function, the processor 12 displays the video recorder interface 30c on the touch screen 14.

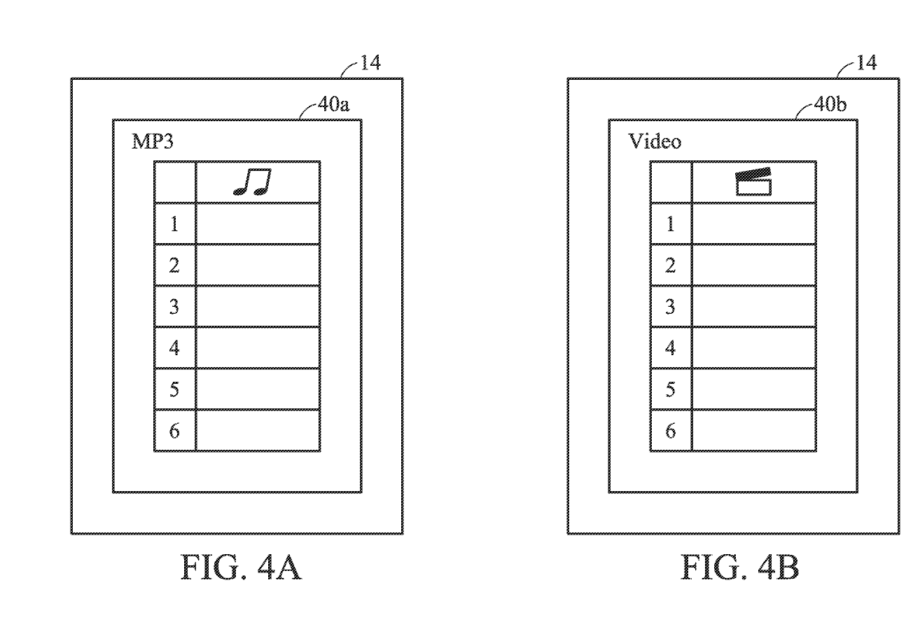

FIG. 4A is a diagram for illustrating a music player menu 40a of the touch screen 14 according to another embodiment of the invention. FIG. 4B is a diagram for illustrating a media player menu 40b of the touch screen 14 according to another embodiment of the invention. In the embodiment, the first function is a music player function, and the second function is a media player function. When enabling the first function, the processor 12 displays the music player menu 40a on the touch screen 14. When enabling the second function, the processor 12 displays the media player menu 40b on the touch screen 14.

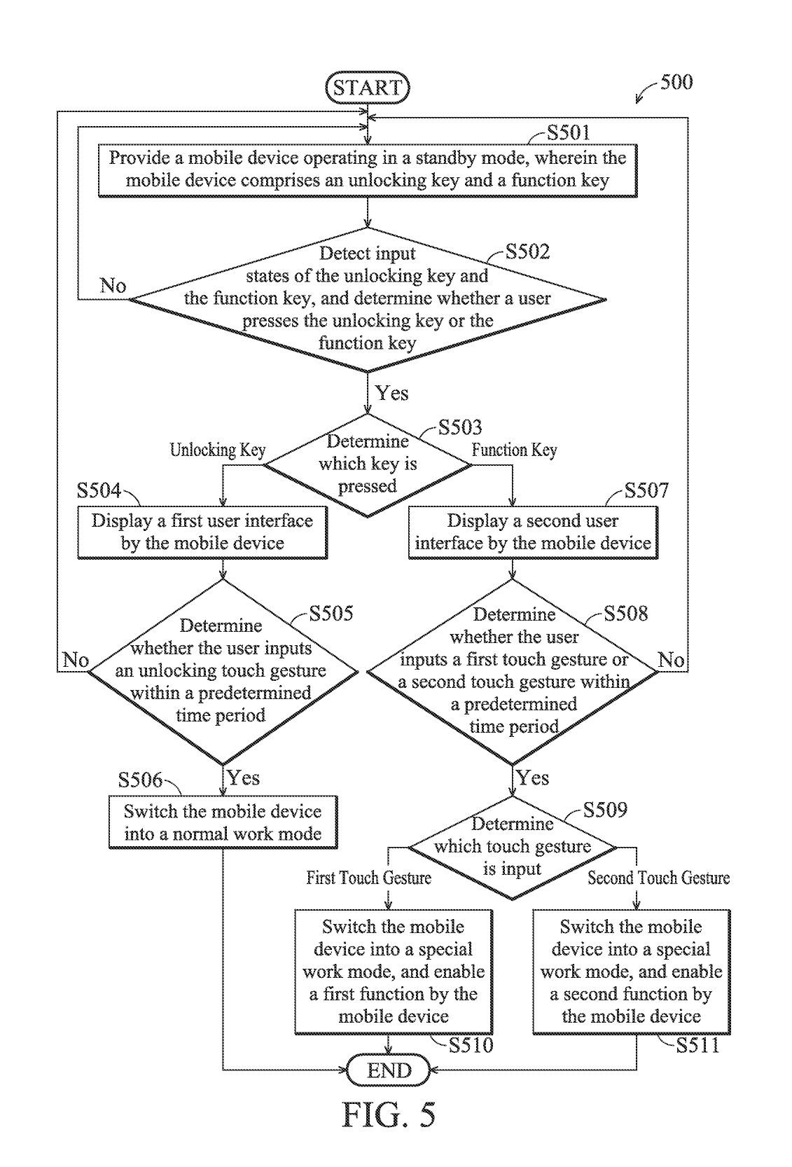

FIG. 5 is a flowchart 500 for illustrating a method for controlling a mobile device according to another embodiment of the invention. To begin, in step S501, a mobile device operating in a standby mode is provided, wherein the mobile device comprises an unlocking key and a function key. In step S502, the input states of the unlocking key and the function key are detected, and whether a user has pressed the unlocking key or the function key is determined If no key is pressed, the mobile device still operates in the standby mode. If any key is pressed, in step S503, which key is pressed is determined If the unlocking key is pressed, in step S504, a first user interface is displayed by the mobile device. Then, in step S505, whether the user inputs an unlocking touch gesture within a predetermined time period is determined If not, the mobile device still operates in the standby mode. If so, in step S506, the mobile device is switched into a normal work mode for user operation (e.g., an application program menu is displayed by the mobile device). On the other hand, referring to step S503, if the function key is pressed, in step S507, a second user interface is displayed by the mobile device. Then, in step S508, whether the user inputs a first touch gesture or a second touch gesture within a predetermined time period is determined If no touch gesture is input, the mobile device still operates in the standby mode. If any touch gesture is input, in step S509, which touch gesture is input is determined If the first touch gesture is input, in step S510, the mobile device is switched into a special work mode, and a first function is enabled by the mobile device. If the second touch gesture is input, in step S511, the mobile device is switched into the special work mode, and a second function is enabled by the mobile device.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A mobile device, comprising:
a touch screen, detecting a touch gesture;
an unlocking key, transmitting a first command when the unlocking key is pressed;
a function key, transmitting a second command when the function key is pressed; and
a processor, coupled to the touch screen, the unlocking key, and the function key, wherein the processor operates in a standby mode and is configured to:
display a first user interface on the touch screen when the processor receives the first command;
display a second user interface on the touch screen when the processor receives the second command;
switch to a normal work mode when the first user interface of the touch screen detects that the touch gesture is an unlocking touch gesture; and
switch to a special work mode and enable a first function when the second user interface of the touch screen detects a first touch gesture.

2. The mobile device as claimed in claim 1, wherein the processor is further configured to:
switch to the special work mode and enable a second function when the second user interface of the touch screen detects a second touch gesture.

3. The mobile device as claimed in claim 1, wherein the first function is a camera function.

4. The mobile device as claimed in claim 2, wherein the second function is a video recorder function.

5. The mobile device as claimed in claim 1, wherein the first function is a music player function.

6. The mobile device as claimed in claim 2, wherein the second function is a media player function.

7. A method for controlling a mobile device, comprising the steps of:
providing the mobile device, wherein the mobile device operates in a standby mode, and comprises an unlocking key and a function key;
detecting input states of the unlocking key and the function key;
when the unlocking key of the mobile device is pressed, displaying a first user interface by the mobile device;
when the first user interface of the mobile device detects an unlocking touch gesture, switching the mobile device into a normal work mode;
when the function key of the mobile device is pressed, displaying a second user interface by the mobile device; and
when the second user interface of the mobile device detects a first touch gesture, switching the mobile device into a special work mode, and enabling a first function by the mobile device.

8. The method as claimed in claim 7, further comprising:
when the second user interface of the mobile device detects a second touch gesture, switching the mobile device into the special work mode, and enabling a second function by the mobile device.

9. The method as claimed in claim 7, wherein the first function is a camera function.

10. The method as claimed in claim 8, wherein the second function is a video recorder function.

11. The method as claimed in claim 7, wherein the first function is a music player function.

12. The method as claimed in claim 8, wherein the second function is a media player function.
